(19) United States
(12) Patent Application Publication
(10) Pub. No.: US 2002/0167949 A1
(43) Pub. Date: Nov. 14, 2002

(54) Apparatus and method for asynchronous transfer mode (ATM) adaptive time domain duplex (ATDD) communication

(76) Inventors: Gordon Bremer, Clearwater, FL (US); Kurt E. Holmquist, Largo, FL (US); Joseph Q. Chapman, Seminole, FL (US); Robert E. Scott, Largo, FL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/179,544

(22) Filed: Jun. 25, 2002

Related U.S. Application Data
(63) Continuation-in-part of application No. 09/031,226, filed on Feb. 26, 1998.
(63) Continuation-in-part of application No. 09/031,226, filed on Feb. 26, 1998.
(63) Continuation-in-part of application No. 09/032,671, filed on Feb. 27, 1998.
(63) Continuation-in-part of application No. 09/537,609, filed on Mar. 29, 2000.
(63) Continuation-in-part of application No. 09/637,185, filed on Aug. 11, 2000.
(60) Provisional application No. 60/128,064, filed on Apr. 7, 1999.

(51) Int. Cl. H04L 12/28; H04L 12/66

(52) U.S. Cl. 370/395.1; 370/474; 370/465; 370/463; 370/351; 370/400

(57) ABSTRACT

Embodiments of the present invention provide communication of Asynchronous Transfer Mode (ATM) data using variable duration ATM frames between a data terminal unit (DTU) at a central office and a remote DTU at a user premises. One embodiment of the present invention can be viewed as a communication device which communicates data in an asynchronous transfer mode (ATM) format, the device comprising at least one buffer configured to receive data from a sending device, and a modulation unit coupled to the buffer and configured to encapsulate a plurality of ATM cells into an ATM frame, the plurality of ATM cells having the received data, so that the ATM frame is communicated onto a subscriber line, such that the communicated ATM frame has a variable transmission duration, the variable transmission duration corresponding to a number of the plurality of ATM cells encapsulated into the ATM frame.

### CLAIM OF PRIORITY AND CROSS REFERENCE TO RELATED APPLICATIONS

This application claims the benefit of U.S. Provisional Patent Application Serial No. 60/128,064, filed on Apr. 7, 1999, attorney docket no. 061606-8140 (1997-24A) and entitled “APPARATUS AND METHOD FOR A NON-SYMMETRICAL HALF-DUPLEX MULTIPOINT DSL MODEM,” and is incorporated herein by reference.

Furthermore, this application is a continuation-in-part of the following utility patent applications:

“APPARATUS AND METHOD FOR A MULTIPOINT DSL MODEM,” Ser. No. 09/031,226, filed Feb. 26, 1998, attorney docket no. 061606-1450 (1997-24),

“APPARATUS AND METHOD FOR SIMULTANEOUS MULTIPLE TELEPHONE TYPE SERVICES ON A SINGLE TELEPHONE LINE,” Ser. No. 09/032,671, filed Feb. 27, 1998, attorney docket no. 061606-1460 (1997-25),

“APPARATUS AND METHOD FOR A NON-SYMMETRICAL HALF-DUPLEX DSL MODEM,” Ser. No. 09/537,609, filed Mar. 29, 2000, attorney docket no. 061606-1451(1997-24a), and

“SYSTEM AND METHOD FOR A ROBUST PREAMBLE AND TRANSMISSION DELIMITING IN A SWITCHED-CARRIER TRANSCEIVER,” Ser. No. 09/637,185, filed Aug. 11, 2001, attorney docket no. 061607-1220 (1999-06), all of the foregoing of which are incorporated herein by reference.

### BACKGROUND OF THE INVENTION

1. Field of the Invention

One embodiment of the present invention generally relates to an apparatus and method that enables one or more data terminal units (DTUs), connected at a user premises via a single subscriber line, to communicate Asynchronous Transfer Mode (ATM) data using variable duration ATM frames, with a DTU at the central office end of the subscriber line, using an open systems interconnect (OSI) physical layer half-duplex data transmission methodology.

2. Background of the Related Art

Data communication on a subscriber line is typically referred to as digital subscriber line (DSL) communication. Examples of DSL technologies are adaptive digital subscriber line (ADSL), rate adaptive digital subscriber line (RADSL), basic rate Integrated Services Digital Network (ISDN), etc. Currently, most DSL communication is physical open systems interconnect (OSI) full duplex. Full duplex DSL communication is usually achieved on a wire pair by either frequency division multiplexing (FDM), echo canceling duplex (ECD), or time division duplexing (TDD).

In FDM, the physical layer transmissions in each direction of communication utilize separate frequency bands with a guard band between these two communication bands. A result is that symmetrical FDM requires more than twice the channel bandwidth than that required for just one communication direction. An additional consequence is that FDM suffers increased channel loss, and hence, reduced performance in one direction. An example of FDM is ADSL as described in ITU Recommendation G.992.1.

In ECD, the physical layer transmissions in the same frequency band in both directions of communication utilize echo canceling to separate transmit and receive signals. A result is that ECD is susceptible to non-linear distortion and other noncancelable impairments of the transmitted signal with a consequence that ECD suffers decreased dynamic range and reduced performance in both directions of communication. An example of ECD is G.shdsl as described in ITU Recommendation G.991.1.

In TDD, the physical layer transmissions alternate in one direction, then the other direction, in pre-arranged, equal time periods. In TDD, both directions of communication utilize the same frequency band and do not require echo canceling, thus avoiding the above disadvantages of FDM and ECD. However, TDD suffers the disadvantage of the maximum data rate in each direction of transmission is at most one-half that achievable in only one direction. Examples of TDD are TCM-ISDN and G.992. 1 Annexes C & H. In FDM, ECD and TDD, the physical layer transmissions are decoupled from and independent of the higher communication layers.

Adaptive Time Domain Duplex (ATDD) data transmissions include physical layer half-duplex transmission on a subscriber line wherein the transmission duration in one direction is different than the transmission duration in the other direction and the duration may change from time to time, and/or the transmission data rate in one direction is different than the transmission data rate in the other direction. Products incorporating ATDD for communication of Ethernet data are offered by Paradyne Corporation with a technologies designated as MVL™ or ReachDSL™. These products and underlying technologies are incapable of ATM communication.

Another ATDD variation restricted to communicating Ethernet data is called “EtherLoop” (developed by Elastic Networks) and also uses FDM, but communicates burst transmissions only for Ethernet messages. These products and underlying technology are incapable of ATM communication.

Most DSL communication in the prior art is point-to-point, in that there is a single DSL modem operating at each end of the subscriber line with no provision for multiple DSL modems to be able to operate at either end. As the singular exception, products incorporating ATDD for multipoint communication of Ethernet data are offered by Paradyne Corporation with a technology designated as multiple virtual lines (MVL™). These enable a single operating DSL modem at one end of the subscriber line to communicate Ethernet data with multiple DSL modems at the other end. These products and underlying technology are incapable of ATM communication.

Some leased line voiceband modems in the prior art provide for a single central site modem which communicates with one or more remote modems: a concept referred to as “four-wire multipoint communications.” An example of such a modem is one that complies with the industry standard ITU V.27bis. The communication channel to which each remote modem is coupled to is a four-wire connection. Modems are typically widely geographically dispersed over the public telephone network. It is important to note that in the dial-line modem prior art, the central site modem transmission is controlled by an attached central site computer or data terminal, which uses non-data control signals. An example of non-data control signals are those prescribed in industry standard ITU V.24 CT105 to control the start and end of transmissions. These products and underlying technology are incapable of ATM communication.

Similarly, some existing public switched telephone network (PSTN) dial line voiceband modems provide for a single central site modem which communicates with one or multiple remote modems, which is a concept referred to as “two-wire PSTN communications.” The communication channel to which each remote modem is coupled to is a two-wire PSTN connection and the modems are, typically, widely geographically dispersed over the public telephone network. The physical layer is half-duplex, and the data protocol is half-duplex. The direction of transmission is determined external from the dial modem and modem transmissions are thus controlled externally by control signals, such as request-to-send or V.24 CT105. These products and underlying technology are incapable of ATM communication.

Importantly, in both prior art voiceband modem cases discussed above, the central site modem and the remote modems are never at both ends of a single subscriber line.

Another example is for remote transmission controlled by an attached remote computer or data terminal which also uses non-data control signals such as those described in industry standard ITU V.24 CT105 to control the start and end of transmissions. In leased line systems, the central site transmission is continuous and the remote site transmission is controlled as in the dial line modem case. In both these cases, the attached computers or data terminals ensure that transmissions do not overlap by monitoring the received signals.

It should be noted that, with respect to the prior art voiceband modem discussed above, communications for one or more remote users are not on the subscriber line and involve transmission control signals from attached computers or data terminals via non-data interfaces. It may be constructive to note that the dial modem techniques are not efficient for use on a subscriber line where much high data rates and faster turnaround times are demanded.

Another prior art technology is referred to as Ethernet local area network communication where the physical channel can be a short two-wire channel (generally not a subscriber line). Here, transmissions are derived directly from the upper layer data protocol, but there is no central control, and therefore, the signals may collide. A special upper layer protocol must manage the detrimental effects of collisions. It may also be constructive to note that the Ethernet techniques cannot be efficiently applied to subscriber lines because of collisions and the inability to span the distances incurred on a subscriber line.

FIG. 1 illustrates a portion of a prior DSL system 10. User premises 12 is connected to a CO 14 via a subscriber line 18. Subscriber line 18 is a conventional line, such as a copper wire pair, configured to communicate POTS signals. Subscriber line 18 further connects to a user premises line 20, for distribution of POTS service and DSL service throughout the user premises 12. DSL modem 22 is connected to user premises line 20. Usually, there are numerous POTS devices connected to each user premises line 20, such as telephones 24, facsimile (fax) machines 26, and the like.

It is noted that POTS splitters (not shown) can be utilized at the user premises 12, when required, to separate the POTS lower frequency band, which is between about 0 kHz and about 4 kHz, from the DSL signals, which are at a higher frequency level than the POTS frequency band. In applications where a user premises POTS splitter is required, the POTS splitter would be on the incoming subscriber line 18, with the DSL modem 22 coupled to one POTS splitter and the two telephones 24 and fax 26 coupled to another POTS splitter.

Subscriber line 18 is connected to a POTS splitter device 28 at the CO 14. POTS splitter 28 separates analog POTS signals from DSL formatted data signals communicated to/from DSL modem 30. POTS signals are accordingly communicated from POTS splitter 28 to a POTS switch 32, via connection 34. POTS signals are communicated by a POTS switch 32 that is connected to the other central offices, via the PSTN 36, via connection 38.

DSL data signals from DSL modem 22 are separated from the POTS analog signals at POTS splitter 28 and are communicated to DSL modem 30, via connection 40. DSL modem 30 is further connected to digital data networks, such as the Internet 42, through a remote access server (RAS) 44, via connections 46 and 48.

A brief discussion will now be provided of an example of the signals that are generated in accordance with the prior art between the user premises 12, transmitted through the CO 14 via either the PSTN 36 or Internet 42, to another device at another user premises. When a user desires to place a telephone call on a telephone 24, the user picks up the telephone 24 and puts the subscriber line 18 in an off-hook condition that is detected at the CO 14 by off-hook detection circuitry (not shown). The off-hook condition signals the CO to accept an outgoing call by allowing a flow of D.C. current and a dial tone of about 480 Hz to be sent to telephone 24. The outgoing telephone call signals are transmitted, as described before, via subscriber line 18 to POTS splitter 28. The analog POTS system signals are separated from DSL modem signals, if present, and the POTS signals are directed towards the POTS switch 32 for transmission, via the PSTN 36, to another telephone (not shown) or device.

A description of digital information signals transmitted to/from the user premises 12 is now provided. When a user desires to transmit data over a digital network via, for example, a personal computer (PC) 50, the digital signals from the PC 50 are transformed into analog signals, and communicated in a full duplex mode by DSL modem 22. The full duplex analog signals are transmitted over the user premises line 20 to the subscriber line 18 for final delivery to the CO 14. The analog signals from DSL modem 22, going into POTS splitter 28, are separated from the analog POTS signals, if present, and are directed to DSL modem 30. DSL modem 30 demodulates the received analog signals to a digital data signal, and transmits the digital data over the Internet 42, via the RAS 44. The digital data signals sent over the Internet 42 are typically received by an internet server 52 at website server 54, via connection 56. Response information is returned to the user along a reverse path.

As discussed above with respect to the prior art, it is necessary to have multiple subscriber lines connected to user premises to be able to have multiple DSL modems at the same user premises 12 simultaneously communicating data with the CO 14. For example, a second subscriber line 58 is coupled to DSL modem 60 so that PC 62 communicates data to DSL modem 64 residing in the CO 14. If DSL modems 60 and 64 are configured to communicate data in a DSL format, a POTS splitter 66 may be employed such that a telephone (not shown) or other suitable device communicates to PSTN 36, via a POTS switch 68. If the subscriber line 58 is configured such that communication is provided exclusively between DSL modems 60 and 64, the POTS splitter 66 and POTS switch 68 may be omitted.

Heretofore, DSL modems have lacked the ability to communicate point-to-point or multipoint ATM data using half-duplex or full duplex transmission on a subscriber line wherein the transmission duration in one direction may be different than the other direction and the duration may change from time to time and/or the transmission data rate in one direction is different than the other direction.

### SUMMARY OF THE INVENTION

Embodiments of the present invention provide an apparatus and method for providing communication of Asynchronous Transfer Mode (ATM) data using variable transmission duration between a data terminal unit (DTU) at a central office and at least one remote DTU at a user premises. One embodiment of the present invention can be viewed as a communication device which communicates data in an asynchronous transfer mode (ATM) format, the device comprising at least one buffer configured to receive data from a sending device, and a modulation unit coupled to the buffer and configured to encapsulate a plurality of ATM cells into an ATM frame, the plurality of ATM cells having the received data, so that the ATM frame is communicated onto a subscriber line such that the communicated ATM frame has a variable transmission duration, the variable transmission duration corresponding to a number of the plurality of ATM cells encapsulated into the ATM frame.

Another embodiment of the present invention can be viewed as a method for communicating data in an asynchronous transfer mode (ATM) format. In this regard, the method can be broadly summarized by the following steps: receiving data; loading information corresponding to the received data into a plurality of ATM cells having a predefined size; encapsulating the plurality of ATM cells into an ATM frame; and communicating the ATM frame onto a subscriber line, such that the communicated ATM frame has a variable transmission duration, the variable transmission duration corresponding to a number of the plurality of ATM cells encapsulated into the ATM frame.

Yet another embodiment of the present invention can be viewed as a method for adjusting a duration that an asynchronous transfer mode (ATM) frame is transmitted. In this regard, the method can be broadly summarized by the following steps: receiving data from a buffer; parsing the received data into a plurality of data portions having information corresponding to a respective portion of the received data, each one of the data portions configured to be loaded into one of a plurality of ATM cells having a predefined size; loading each one of the data portions into a corresponding one of the plurality of ATM cells until all the data portions have been loaded; generating the ATM frame by encapsulating the plurality of ATM cells into the ATM frame consisting of the ATM cells and beneficial supplementary information; and communicating the ATM frame onto the subscriber line, such that the communicated ATM frame has a variable transmission duration, the variable transmission duration corresponding to a number of the plurality of ATM cells encapsulated into the ATM frame.

Other features and advantages of the present invention will become apparent to one with skill in the art upon examination of the following drawings and detailed description. It is intended that all such additional features and advantages be included herein within the scope of the present invention.

### BRIEF DESCRIPTION OF THE DRAWINGS

The invention can be better understood with reference to the following drawings.

The components in the drawings are not necessarily to scale, emphasis instead being placed upon clearly illustrating the principles of the present invention. Moreover, in the drawings, like reference numerals designate corresponding parts throughout the several views.

FIG. 1 is a view of the central office (CO) wire centers and user premises layout of the prior art.

FIG. 2 is a view of the CO and user premises having an embodiment of the present invention.

FIG. 3 is a view of the CO and user premises having an embodiment of the present invention configured for multi-point operation.

FIG. 4 is a block diagram of the connections between the CO and a plurality of data terminal units-remote (DTU-Rs) at the user premises as shown in FIG. 3.

FIG. 5 is a block diagram illustrating the open systems interconnect (OSI) 7-layer model in accordance with the present invention.

FIG. 6A is a block diagram of an embodiment of a multichannel data communications device DTU-C constructed in accordance with the present invention.

FIG. 6B is a block diagram of an embodiment of a DTU-R constructed in accordance with the present invention.

FIG. 7 is a block diagram illustrating an adaptive time division duplexing (ATDD) asynchronous transfer mode (ATM) frame in accordance with the present invention.

FIG. 8A is a schematic diagram showing a poll from the DTU-C with no ATM cells (no data), followed by a response from the DTU-R with no data.

FIG. 8B is a schematic diagram showing a poll from the DTU-C with ATM cells (data), followed by a response from the DTU-R with no data.

FIG. 8C is a schematic diagram showing a poll from the DTU-C with no ATM cells (no data), followed by a response from the DTU-R with ATM cells.

FIG. 8D is a schematic diagram showing a poll from the DTU-C with ATM cells (data), followed by a response from the DTU-R with ATM cells.

FIG. 9A is a block diagram of an example that represents a “downstream intensive” application for the DTUs of FIGS. 6A and 6B, where transmission time is dedicated to downstream transmission, with the exception of necessary upstream overhead information.

FIG. 9B is a block diagram of an example that represents an “upstream intensive” application for the DTUs of FIGS. 6A and 6B, where transmission time is dedicated to upstream transmission, with the exception of necessary downstream overhead information.

FIG. 9C is a block diagram of an example that represents a “symmetrical” application for the DTUs of FIGS. 6A and 6B, where transmission time is dedicated equally to downstream and upstream transmission, and where the overhead information is included in the upstream and downstream transmissions.

FIG. 9D is a block diagram of an example that represents changing point-to-point application for the DTUs of FIGS. 6A and 6B, where the application is initially “upstream intensive” and changes to “downstream intensive.”

### DETAILED DESCRIPTION

In the descriptions of the embodiments of the present invention that follow, the terminology “DTU-R” refers herein to a “data terminal unit-remote” which is a transceiver located at a user premises. Non-limiting examples of user premises include a residence, a business, or another site wherein access to a subscriber line or other suitable communication medium is provided for the DTU-R. The terminology “DTU-C” refers herein to a “data terminal unit-central office.” A DTU-C is a transceiver located at a site configured to receive a plurality of signals from at least one bulk source (in which many individual communications are transported) to a plurality of user premises, where each user premises is coupled to the CO via a single subscriber line. Non-limiting examples of a central office (CO) include a telephone central office, a telephone digital loop carrier site, or a functionally similar facility on a campus or business complex. One embodiment of a DTU-R is referred to as a “modem” when the DTU-R is coupled to or incorporated into, or with, a personal computer or similar communication appliance.

Embodiments of the present invention are generally directed to point-to-point and/or multipoint systems, and communication of variable length asynchronous transfer mode (ATM) frames, consisting of zero, one or a plurality of ATM cells and beneficial supplementary information, via a physical layer half-duplex data communication system. In one embodiment, ATM frames are communicated between one DTU-R, over a single subscriber line, to a single DTU-C at the other end of the subscriber line. In another embodiment, multiple DTU-Rs communicate with the single DTU-C over a single subscriber line, referred to herein as multi-point operation, thereby providing virtual simultaneous data sessions between each one of the DTU-Rs and the DTU-C. In yet another embodiment, multiple DTU-Rs communicate with the single DTU-C over a multiple subscriber lines connected at the CO, referred to herein as multi-premises operation, thereby providing virtual simultaneous data sessions between each one of the DTU-Rs and the DTU-C sharing a common communication medium. Furthermore, another embodiment allows two or more DTU-Rs sharing a common communication medium to communicate with each other. Other embodiments communicate ATM data over other types of shared common communication mediums, such as, but not limited to, wire systems, wireless systems, optical systems, acoustic systems or other physical systems.

Data communication between DTUs according to the present invention creates the appearance to the user of the DTU-R that full duplex ATM communication is being achieved. The appearance of full duplex ATM communication is achieved so that the data rate and performance in each direction can equal the full data rate capacity and full performance potential of the subscriber line at moments when no other user data communication is in progress. Accordingly, when one DTU-R is communicating with one DTU-C, full data rate capacity and full performance potential is realized.

At times when user data communication in both directions is required at the same moment, such as when a plurality of DTU-Rs are in communication with the DTU-C, the present invention creates the appearance that the full data rate capacity of the subscriber line is shared in each direction. Accordingly, the present invention enables the full data rate capacity and full performance potential of the subscriber line to be utilized when a plurality of DTU-Rs are in communication with the DTU-C.

Embodiments of the present invention achieve the above desirable attributes without requiring the excessively high channel bandwidth utilization of frequency division multiplex (FDM), or the reduced performance of echo canceling duplex (ECD). Embodiments of the present invention also achieve twice the data rate in each direction of transmission than that of time division duplexing (TDD). These attributes are achieved without control by an external computer or data terminal. These embodiments use a communication methodology referred to as Adaptive Time Domain Duplexing (ATDD). ATDD is an improvement upon TDD. With ATDD the 50% duty cycle of TDD is replaced by a duty cycle (transmission duration) that adaptively and near-instantaneously varies from near 0% to near 100% based on protocol responsive to the ATM data communication needs in each direction of transmission. Accordingly, the amount of data in an ATM frame communicated with ATDD is variable depending upon current communication requirements.

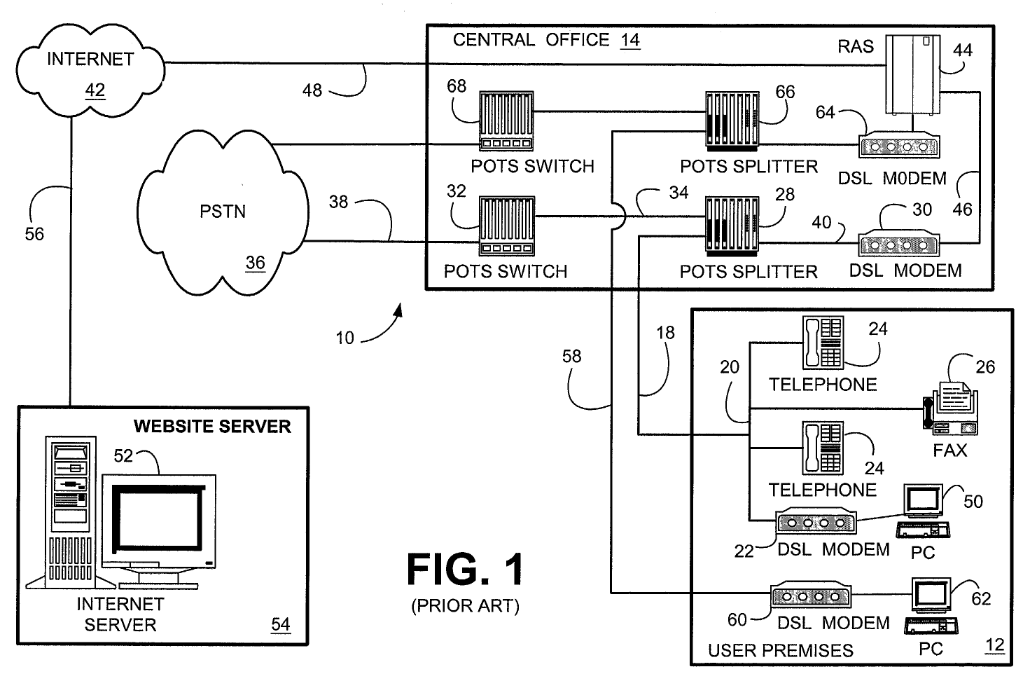

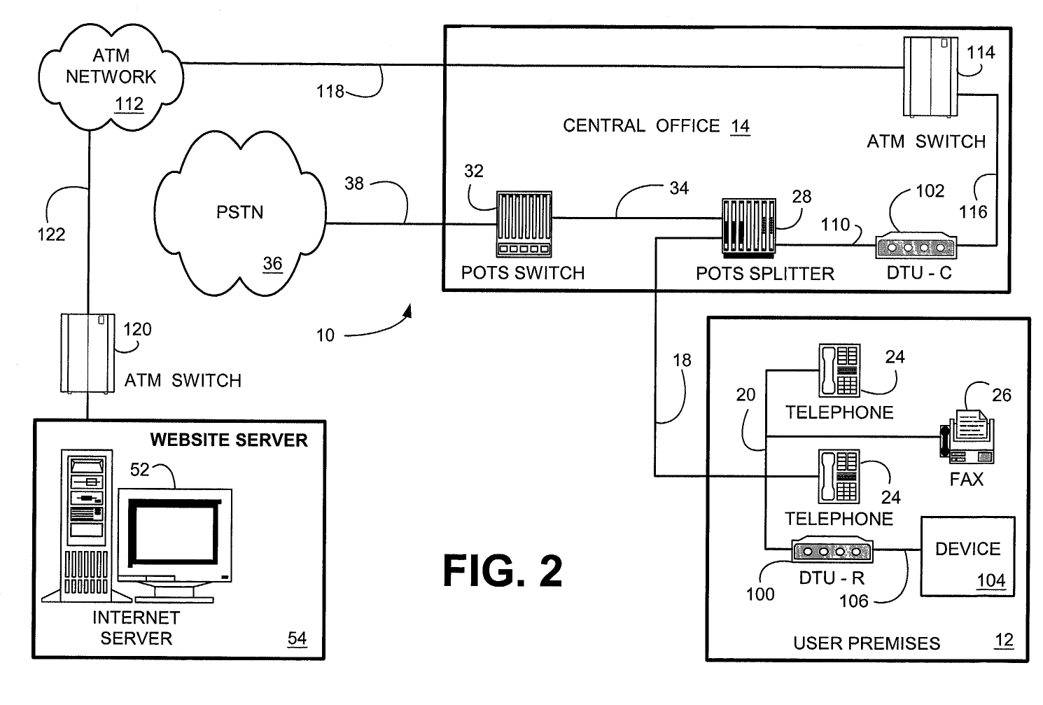

FIG. 2 illustrates a user premises 12 and a CO 14 in accordance with the present invention. DTU-R 100, connected to a single subscriber line 18, communicates data with a single DTU-C 102 at the end of the subscriber line 18. Note specifically that FIG. 2 suggests that DTU-C data is sent to a single personal computer (PC) 50 (FIG. 1) coupled to the DTU-R 100, but the present invention also applies to another embodiment of DTU-R 100 that is configured to support a plurality of PCs and/or other devices using a single DTU-R.

Accordingly, a device 104, coupled to DTUR-100 via connection 106, communicates to CO 14 using an embodiment of the present invention. Device 104 may be any suitable device, such as a PC 50 (FIG. 1), that communicates data using the present invention. Accordingly, it is understood that the present invention is not limited by the type or nature of the device 104.

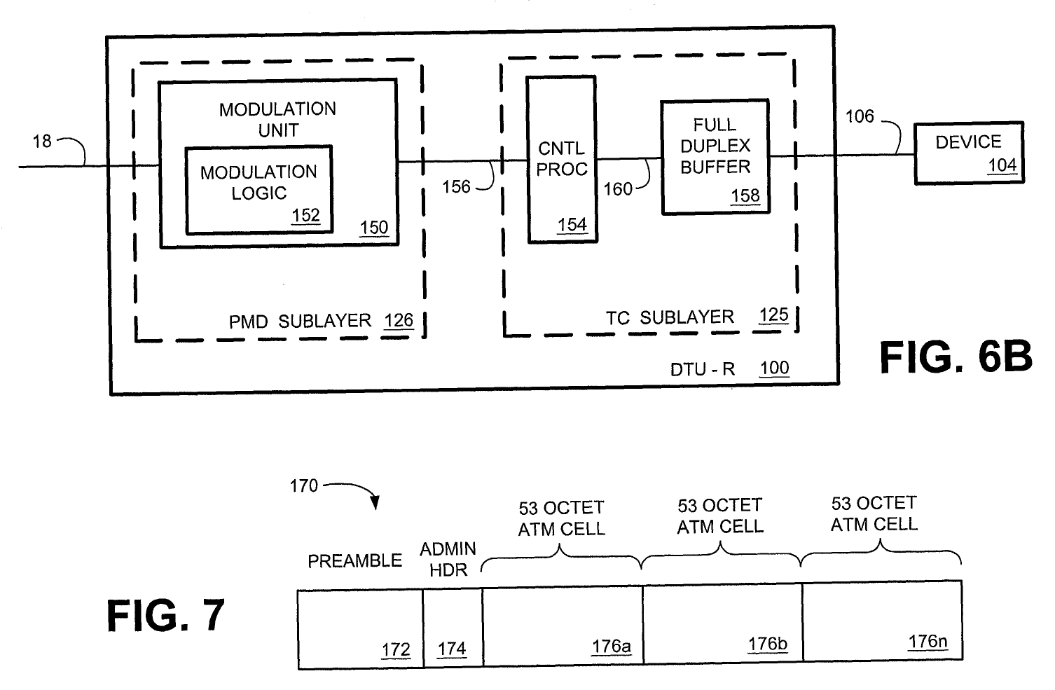

Data from device 104 is communicated to DTU-R 100. DTU-R 100, as described in detail herein, processes the received data, according to the present invention, into an ATM frame 170 (FIG. 7). The ATM frame 170 is then communicated to DTU-C 102, via subscriber line 18. Since the ATM frame 170 is communicated using a DSL transmission medium, as described in detail herein, POTS splitter 28 communicates the received ATM frame 170 to the DTU-C 102, via connection 110. DTU-C 102 further processes the received ATM frame 170 into a signal suitable for communication over an ATM network 112. Accordingly, DTU-C 102 communicates the processed data to ATM switch 114, via connection 116. ATM switch 114 communicates the data to ATM network 1 12, via connection 118.

As an illustrative example, the data is received from the ATM network 112 by another ATM switch 120, via connection 122, such that the data is received at the website server 54. Data communicated form devices coupled to the website server 54 communicate data to device 104 along the reverse path. It is understood that the data may be communicated to/from any device or system that is configured to communicate with the ATM network 112.

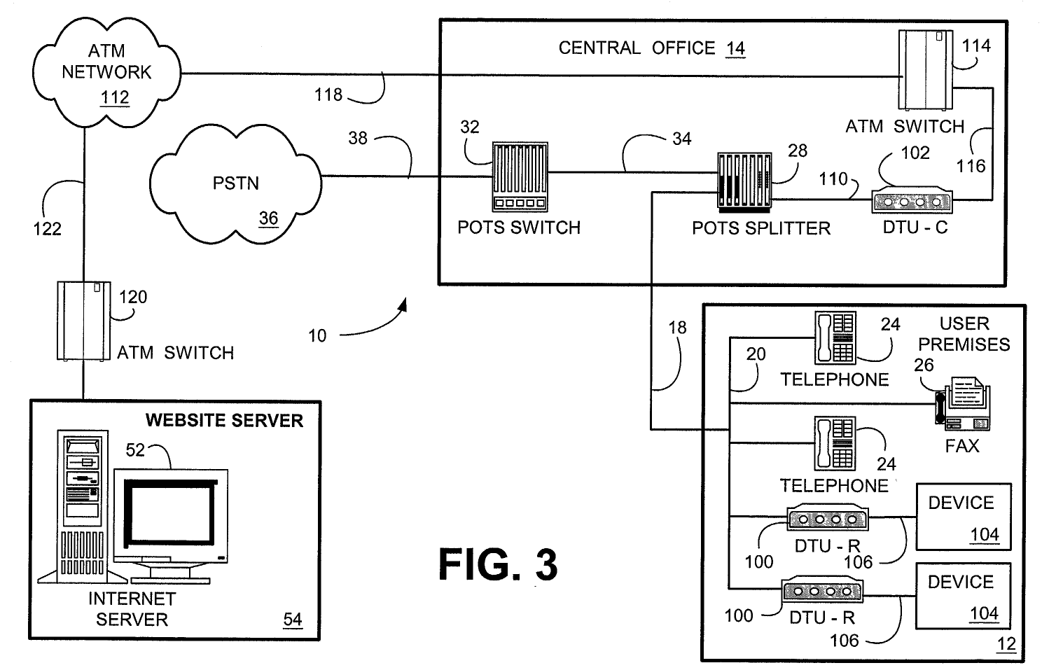

FIG. 3 illustrates a user premises 12 and a CO 14 in accordance with another embodiment of the present invention. A plurality of DTU-Rs 100 are connected to a single subscriber line 18 to communicate data with a single DTU-C 102 at the end of the subscriber line 18. Note specifically that FIG. 3 suggests that data is communicated to/from a single PC 50 (FIG. 1) coupled to the DTU-Rs 100, but the present invention also applies to an embodiment of DTU-R 100 that is configured to support one or more PCs and/or other devices using a single DTU-R.

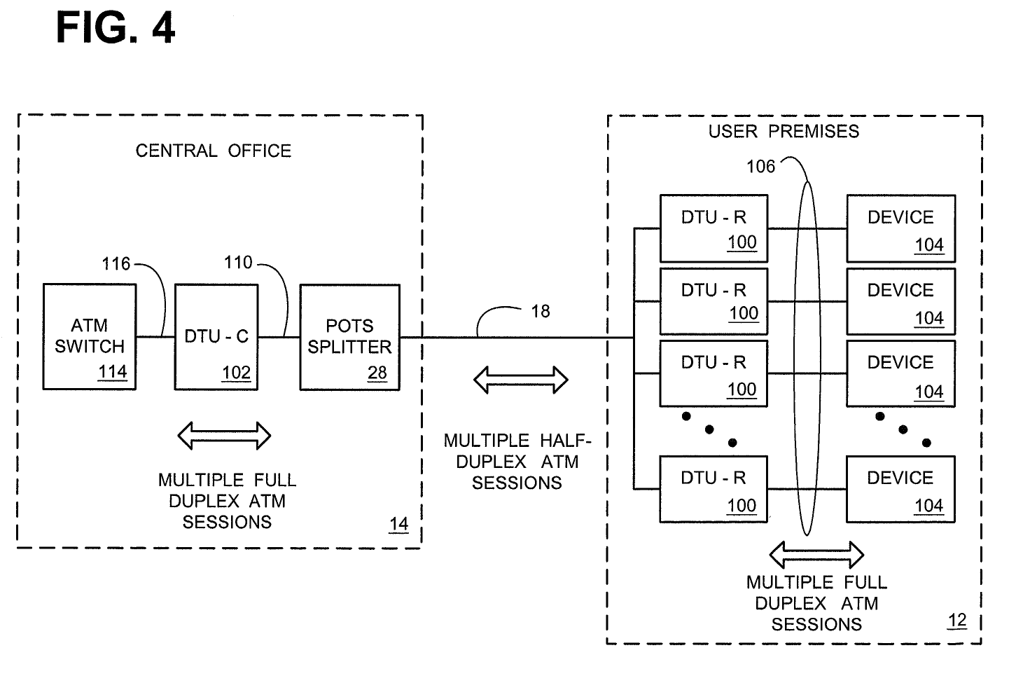

FIG. 4 is a block diagram of the connections 106 between a plurality of DTU-Rs 100 and a plurality of devices 104 residing at the user premises. These connections 106 enable one or more devices 104 to communicate with other devices, such as, but not limited to ATM switch 114, via CO 14. The DTU-Rs 100 are connected to a single subscriber line 18 to communicate data with a single DTU-C 102 at the CO 14.

As also illustrated in FIG. 4, the communication between ATM switch 114 and the DTU-C 102 occurs utilizing one or more full duplex ATM sessions over interface line 110. Communication between the single DTU-C 102 and the one or more DTU-Rs 100 across the single subscriber line 18 occurs utilizing one or more half-duplex ATM sessions. Communications between a DTU-R 100 and a device 104 occurs utilizing one or more full duplex ATM sessions over connections 106.

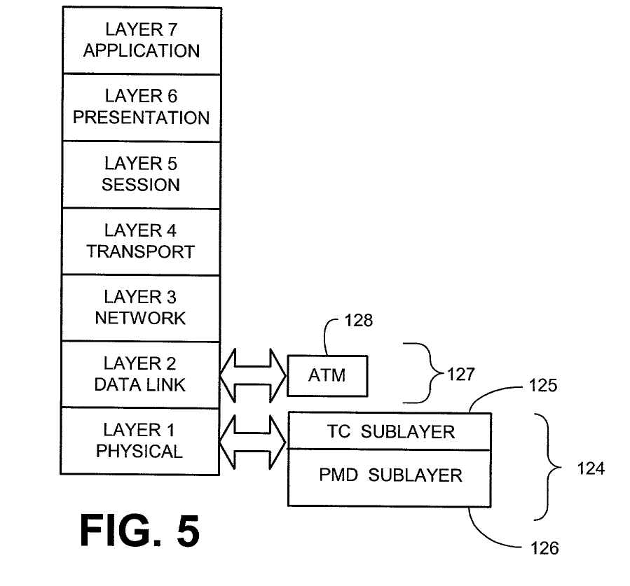

FIG. 5 is a block diagram illustrating the open systems interconnect (OSI) 7-layer model, including information relating to the physical and data link layers, in accordance with the present invention. As shown in FIG. 5, the physical layer 124 contains two distinct sub-layers, the transmission convergence (TC) sublayer 125 and the physical media dependent (PMD) sublayer 126. The PMD sublayer 126 handles the aspects that are dependent on the transmission medium selected. For example, but not limited to, one embodiment employs the transmission medium of subscriber line 18 (FIGS. 2-4).

PMD sublayer 126 specifies the physical medium and the transmission characteristics (e.g., bit timing, line coding) that is used to communicate information over the subscriber line 18. However, PMD sublayer 126 does not include framing or overhead information. The PMD sublayer 126 may include, in one embodiment, special signals to identify the beginning and/or the end of a transmission signal.

TC sublayer 125 handles the physical layer aspects which are independent of the transmission medium. The functions comprising the TC sublayer 125 involve the generation and processing of overhead information contained within an ATM frame communicated with ATDD according to the present invention.

In one embodiment, the data link layer 127 uses an ATM protocol 128. The invention described herein specifies techniques that enable ATM data to be communicated using a half-duplex physical layer methodology over the subscriber line 18 (FIGS. 2-4). Accordingly, one DTU-C 102 can service one or more DTU-Rs 100, with each DTU-R 100 appearing to receive a unique ATM session.

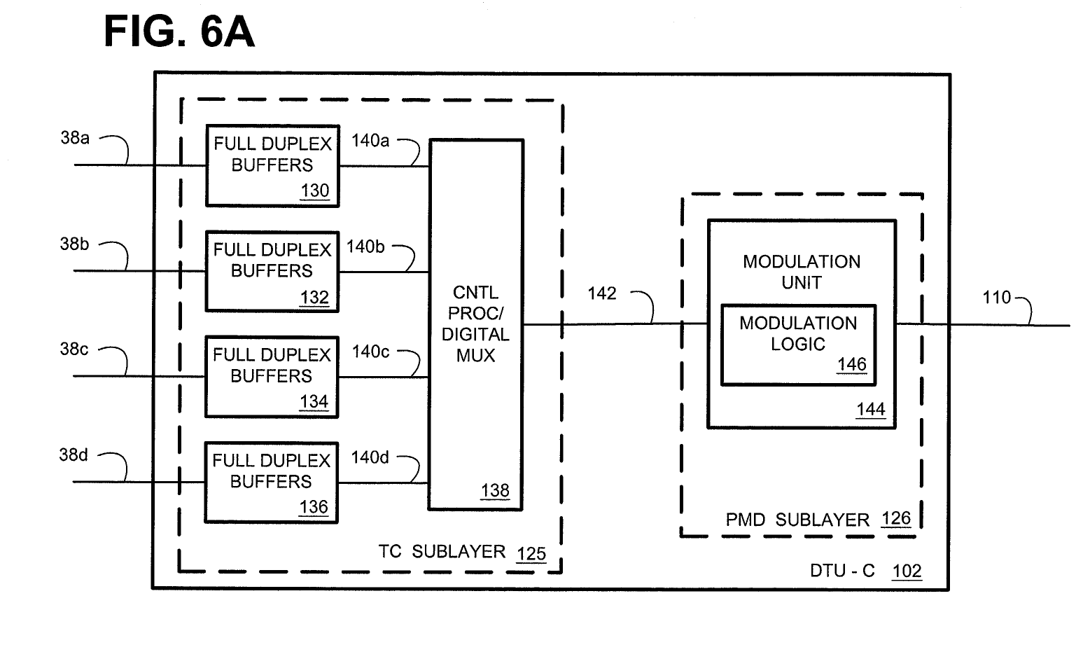

FIG. 6A is a block diagram of an embodiment of a multichannel data communications device DTU-C 102 constructed in accordance with the present invention. The multichannel data communication device DTU-C 102 is connected, via connection 110, to a POTS splitter 28 (FIGS. 2-3), thereby providing connectivity to the subscriber line 18. In FIG. 6A, one or more full duplex ATM sessions are transported over interface lines 38a-d to the full duplex buffers 130, 132, 134 and/or 136, respectively. The full duplex buffers 130, 132, 134 and/or 136 include circuitry to convert serial data streams into parallel data. Accordingly, each full duplex ATM session may be carried over a separate interface line 38a-d.

Received data accumulated in full duplex buffers 130, 132, 134 and/or 136 is communicated to a control processor/digital multiplexor 138, or another suitable interface, such as, but not limited to, a Utopia interface, via connections 140a, 140b, 140c and 140d, respectively. Thus received ATM data is multiplexed onto a single connection 142 using a suitable multiplexing process.

Upon detection of ATM data on connection 142 having one or more cells from any of the full duplex buffers 130, 132, 134 and/or 136, the modulation unit 144 receives and encapsulates the ATM data, as described below in greater detail in FIG. 7. ATM data is encapsulated into one or more ATM frames according to the present invention when the modulation logic 146 is executed by the modulation unit 144. In one embodiment, modulation unit 144 is a modulator. In another embodiment, modulation unit 144 is a modulator/demodulator unit. The ATM frames are communicated onto connection 110 such that the ATM frames are received by a destination DTU-R 100, as defined by an address identifying the destination DTU-R 100.

FIG. 6A further illustrates the relationship between the TC sublayer 125 and the PMD sublayer 126 (see also FIG. 5) and the DTU-C 102. Thus, full duplex buffers 130, 132, 134 and/or 136, and the control processor/digital multiplexor 138 operates within the TC sublayer 125 as defined by the OSI 7-layer model. Modulation unit 144 operates within the PMD sublayer 126 as defined by the OSI 7-layer model.

FIG. 6B is a block diagram of an embodiment of a DTU-R 100 constructed in accordance with the present invention. DTU-R 100 demodulates a received signal having an ATDD ATM frame 170 (FIG. 7) transmitted by DTU-C 102 over subscriber line 18. The received signal is demodulated by modulation unit 150 executing the modulation logic 152.

Modulation unit 150 communicates the demodulated ATDD ATM frame to control processor 154, via connection 156, so that the encapsulated ATM data is extracted from the received ATM frame 170. Control processor 154 checks for address of the DTU-R 100 (corresponding to destination device 104), and for errors in the ATM frame 170, by analyzing information in the ATM frame 170. If no errors exist, control processor 154 determines if the ATM frame 170 is intended to be communicated to its corresponding destination device 104 by comparing address information in preamble 172 (FIG. 7) in the received ATM frame 170 with an address assigned to the DTU-R 100, described in greater detail below. If the address information indicates that the received communication is intended for a particular DTU-R 100 (and its corresponding destination device 104), the control processor 154 checks for ATM cells 176a, 176b through 176n (FIG. 7), described in greater detail below. If at least one ATM cell exists in a received ATM frame, the ATM cell is placed into fall duplex buffer 158, via connection 160. The full duplex buffer 158 communicates the ATM cell(s) to the destination device 104, via connection 106. In another embodiment, the data in the ATM cells is converted into a suitable data format receivable by the destination device 104.

Since the ATDD ATM session on connection 106 operates in full duplex mode, destination device 104 can, at any time, transfer an ATM cell into fall duplex buffer 158. When a poll, described in greater detail below, is detected on subscriber line 18, DTU-R 100 is enabled to communicate information to the DTU-C 102. Accordingly, if data generated by the destination device 104 exists in the full duplex buffer 158, the data is parsed into data portions. Information corresponding to the data portions is loaded into the ATM cells. ATM cells having information corresponding to the data portions are then encapsulated into an ATM frame 170, described in greater detail below, by control processor 154. The term “parse” as used herein, in one embodiment, means to subdivide the data into portions such that the information loaded into an ATM cell is a predefined fixed size corresponding to the size of an ATM cell.

The ATM frame 170 is sent to modulation unit 150 for modulation and communication onto the subscriber line 18. If no data (ATM cells) is available to send, the control processor 154 sends a signal indicative of no data to modulation unit 150. Modulation unit 150 executes the modulation logic 152, and then communicates this response (no data) over subscriber line 18 to the DTU-C 102.

FIG. 6B further illustrates the relationship between the TC sublayer 125 and the PMD sublayer 126 (see also FIG. 5) and the DTU-R 100. Thus, full duplex buffer 158 and the control processor 154 operate within the TC sublayer 125 as defined by the OSI 7-layer model. Modulation unit 150 operates within the PMD sublayer 126 as defined by the OS 7-layer model.

The ATDD communication methodology used in embodiments of the present invention employ a physical layer half-duplex data communications apparatus and method. Accordingly, communication on a single subscriber line 18 (FIGS. 2-4) occurs in one direction at a time. One embodiment of ATDD employs poll/response format, whereby the DTU-C 102 controls which of the user premises multiple DTU-Rs 100 (and DTU-C 10-2) are allowed to transmit on the subscriber line 18. A “poll” is a transmission from the DTU-C 102 to the DTU-Rs 100 coupled to subscriber line 18. A “response” is a transmission from the DTU-Rs 100 to the DTU-C 102. To avoid simultaneous transmissions on the line, a poll will usually occur followed normally by a response. For cases in which a response from a DTU-R 100 that has no data (i.e.; no ATM cells to send), “silence” is a legitimate response that the DTU-C 102 recognizes. Alternative embodiments may include padding and/or at least one predefined symbol, in a poll or response.

FIG. 7 is a block diagram illustrating an exemplary ATDD ATM frame 170 in accordance with the present invention. One embodiment of the ATM frame 170 includes a preamble 172, an optional administrative header 174, and zero, one or a plurality of 53 (fifty-three) octet ATM cells 176a, 176b and 176n. Preamble 172 contains information used to address the DTU-R 100 that is the intended destination of the communication.

Administrative header 174 is optional and can be used to send information that is neither part of the preamble 172 or of any data to follow. For example, the administrative header 174, in one embodiment, conveys a description of noise level conditions at receiving end so that the responding DTU may increase or reduce the power level and/or the transmission rate of its transmission. Accordingly, power levels and transmission rates are variable depending upon actual operating conditions on the communication system.

Administrative header 174 could contain information regarding the amount of payload information (number of ATM cells) that the transmitting DTU is ready to transmit, and its relative priorities, so that the sending and the receiving DTUs could alter the duration (amount of time) that the sending DTU is given to transmit its data (relative to any other DTUs connected to the line). As described below in greater detail, the duration, in one embodiment employing ATDD communication, is determined by the number of ATM cells encapsulated into the communicated ATM frame 170.

Furthermore, a communication from a DTU-C 102 (FIG. 3) can specify which of the DTU-Rs 100 is to receive the communication by specifying an address for the intended receiving DTU in preamble 172. Accordingly, multipoint operation for ATDD communication is supported.

Control processor/digital mutiplexer 138 (FIG. 6A) creates an ATM frame 170 by encapsulating at least one ATM cell with at least preamble 172. An ATM cell has a portion of the data that is being communicated between the DTUs. For convenience, a plurality of ATM cells 176a, 176b through 176n are illustrated to indicate that the number of ATM cells encapsulated into an ATM frame 170 is variable. The data is parsed into discrete data portions, the size of each data portion being determined based upon design of the communication system. Thus, one data portion resides in an ATM cell. For illustrative purposes, the ATM cells 176a, 176b through 176n are illustrated as 53 octet ATM cells. In alternative embodiments, size of an ATM cell may be based upon any suitable standard that the DTUs have been designed to.

Accordingly, the length of a communicated ATM frame is variable because the number of ATM cells encapsulated into an ATM frame 170 is variable. Furthermore, the variable length ATM frame, having a plurality of ATM cells, provides for a variable transmission duration, thus providing the above-described ATDD communication according to the present invention. That is, variable transmission duration is provided by controlling the number of ATM cells that are encapsulated in an ATM frame 170. The determination of the number of ATM cells encapsulated in an ATM frame 170 is determined by a variety of factors, such as, but not limited to, the DTU-C/DTU-R buffer size, the number of DTU-R units communicating on a subscriber line 18 at the time of the communication and/or the priority of communications.

In a simplified illustrative example, a DTU-R 100 (FIG. 6B) is the sending DTU. If the full duplex buffer 158 has sufficient capacity, and the device 104 (FIG. 6B) is transmitting sufficient information to keep the full duplex buffer 158 filled with some amount of data, control processor 154 encapsulates the data, as ATM cells, into an ATM frame 170 for as long as data is retrievable from the full duplex buffer 158. When data is no longer available from full duplex buffer 158, such as when the device 104 stops transmitting or if the full duplex buffer 158 is emptied faster than device 104 provides information, the ATM frame 170 is completed and sent (described in greater detail below). Accordingly, DTU-R 100 communicates a variable length ATDD ATM frame 170 onto subscriber line 18, thereby communicating using a variable transmission duration.

In one embodiment, the maximum size of an ATM frame 170 is limited. Thus, even though more data is available in full duplex buffer 158, the control processor 154 terminates the ATM frame 170 after a predefined number of ATM cells have been encapsulated into the ATDD ATM frame 170. Accordingly, other DTU-Rs may take their turn in communicating (receiving from and/or transmitting to the DTU-C) over subscriber line 18. Eventually, DTU-R 100 will have its next turn to communicate another ATM frame 170.

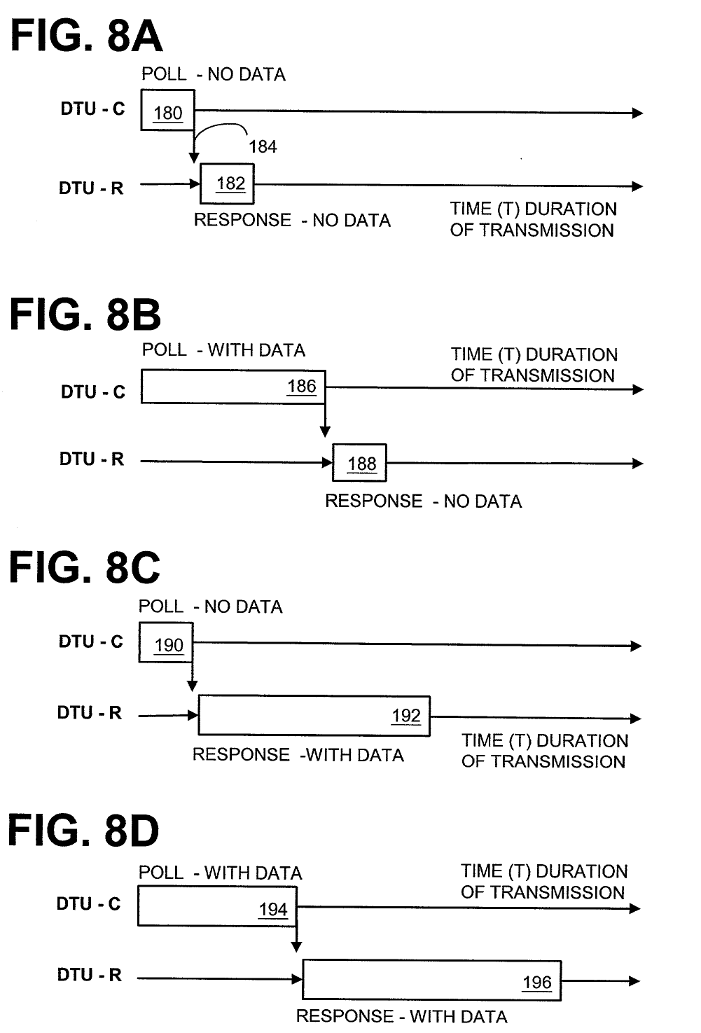

FIGS. 8A-D are schematic diagrams illustrating the communication of ATDD ATM frames that enable simultaneous support of one or more DTU-Rs by a DTU-C. In the simple illustrative examples of FIGS. 8A-D, a single DTU-R 100 and a DTU-C 102 are in communication on subscriber line 18 (FIG. 2). However, it is understood that communications can be supported for more than one user premises DTU-Rs 100 (see FIG. 3), thereby supporting virtual simultaneous communication between three or more DTUs on the same local line.

The transmission methodology used in the preferred embodiment of the physical layer half-duplex ATDD data communications is referred to herein as ATDD communication, whereby the transmission on a single subscriber line occurs in one direction at a time. One embodiment of ATDD employs a poll/response format, whereby the DTU-C 102 controls which of the user premises multiple DTU-Rs 100 on the subscriber line 18 is allowed to transmit at a given time. A “poll” is a transmission from the DTU-C 102, while a “response” is a transmission from a user premises DTU-R 100. To avoid simultaneous transmissions by multiple DTU-Rs 100 on the subscriber line 18, a poll will be followed normally by a response. For cases in which a response has no data, “silence” is a legitimate response. DTU-C 102 will recognize this as a response with no data. Alternative embodiments may include at least one ATM cell having no data, referred to as padding, or a predefined symbol, in a response.

The start of a poll or a response is indicated by the PMD sublayer 126 (FIG. 5) turning on the carrier. The end of a poll or a response is indicated by the PMD sublayer 126 turning off the carrier. In one embodiment, the turning on and off of the carrier indicates the start and the stop, respectively, of communications.

FIGS. 8A-D are schematic diagrams demonstrating four respective modes for a poll/response cycle. The start of a poll or a response is indicated by the PMD sublayer 126 (FIG. 5) turning on the carrier. The end of a poll or a response is indicated by the PMD sublayer 126 turning off the carrier.

FIG. 8A demonstrates a poll 180 with no data communicated from the DTU-C 102 to the DTU-R 100. Poll 180 is an ATDD ATM frame that includes an address in the ATDD ATM frame 170 (FIG. 7) that corresponds to the predefined address of the DTU-R 100. When other DTU-Rs are operating on the subscriber line 18, the other DTU-Rs understand that the poll 180 is not intended for them because the address in the ATDD ATM frame 170 does not correspond to their predefined address. In this simplified illustrative example, the poll 180 from DTU-C 102 with no ATM cells (no data) is followed by a response 182 from the DTU-R 100 with no ATM cells (no data). The timing of the response is determined by the end of the poll 180, as indicated by the arrow 184.

Such a communication between DTU-C 102 and DTU-R 100 is appropriate when DTU-C 102 determines that it is permissible for DTU-R 100 to communicate data to DTU-C 102. However, DTU-R 100 has indicated in the response that is has no data to communicate. Accordingly, if other DTU-Rs are operating on the same subscriber line 18, the DTU-C 102 may then communicate polls to the other DTU-Rs (sequentially) to indicate that it is their “turn” to communicate data to DTU-C 102.

FIG. 8B demonstrates a poll 186 with ATM cells (data) communicated from the DTU-C 102 to the DTU-R 100. In this simplified illustrative example, the poll 186 from DTU-C 102 is an ATDD ATM frame 170 with at least one ATM cell (data). The poll 186 from DTU-C 102 is followed by a response 188 from the DTU-R 100 with no ATM cells (no data). Such a communication between DTU-C 102 and DTU-R 100 is appropriate when DTU-C 102 communicates data to DTU-R 100, and then determines that it is permissible for DTU-R 100 to communicate data to DTU-C 102. However, DTU-R 100 has indicated in the response 188 that is has no data to communicate. Accordingly, if other DTU-Rs are operating on the same subscriber line 18, the DTU-C 102 may then communicate polls to the other DTU-Rs (sequentially) to indicate that it is their “turn” to communicate data to DTU-C 102. Alternatively, if DTU-C 100 has additional data to communicate to DTU-R 100, the data may then be communicated.

FIG. 8C demonstrates a poll 190 with no data communicated from the DTU-C 102 to the DTU-R 100. In this simplified illustrative example, the poll 190 from DTU-C 102 with no ATM cells (no data) is followed by a response 192 from the DTU-R 100 with ATM cells (data). That is, DTU-C 102 has indicated, with the ending of poll 190, to DTU-R 100 that it is its “turn” to communicate data. Accordingly, DTU-R 100 then responds by communicating response 192, an ATDD ATM frame 170 having at least one ATM cell (data). Such a communication between DTU-C 102 and DTU-R 100 is appropriate when DTU-C 102 determines that it is permissible for DTU-R 100 to communicate data to DTU-C 102 (and DTU-R 100 has indicated in the response that is has data to communicate).

FIG. 8D demonstrates a poll 194 with ATM cells (data) communicated from the DTU-C 102 to the DTU-R 100. In this simplified illustrative example, the poll 194 from DTU-C 102 is an ATDD ATM frame 170 with at least one ATM cell (data). The poll 194 for DTU-C 102 is followed by a response 196 from the DTU-R 100. Response 196 is an ATDD ATM frame 170 having at least one ATDD ATM cell (data). That is, DTU-C 102 has both communicated data to DTU-R 100 and that it is now time for DTU-R 100 to communicate data. Accordingly, DTU-R 100 responds by communicating an ATDD ATM frame 170 having at least one ATM cell (data).

Also demonstrated in FIGS. 8A-D is that the transmission duration in one direction can be different than the transmission duration in the opposite direction. Specifically, as seen in FIG. 8B, the transmission duration from DTU-C 102 to DTU-R 100 is greater in time than the transmission duration from DTU-R 100 to DTU-C 102. Differing transmission duration is also illustrated in FIGS. 8C and 8D. Accordingly, FIGS. 8A-D illustrate the transmission duration of the half-duplex capability of the present invention.

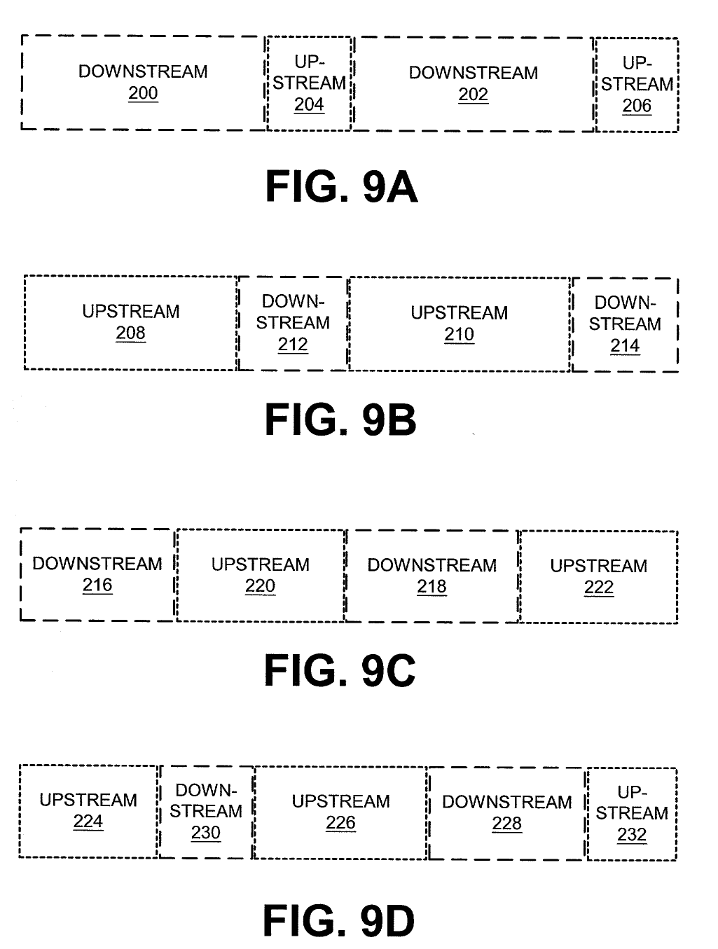

Illustrated in FIGS. 9A-D are examples of subscriber line communication that include several types of point-to-point applications that each benefit from different data rates and different transmission times in each direction of transmission. These same concepts can also be applied to those applications where multipoint DTU-Rs are deployed.

FIG. 9A illustrates an example of a point-to-point application that is “downstream intensive.” A downstream intensive application is utilized when there is a desire to move information as quickly as possible from the DTU-C 102 (FIG. 2) to the DTU-R 100. In the downstream intensive application, transmission duration is dedicated to the downstream transmission with the exception of any necessary upstream confirmation information. This upstream confirmation information is dictated by the ATM link layer communication protocol. As shown in FIG. 9A, the downstream transmission of the ATDD ATM data 200 and 202 is interspersed with the upstream the ATDD ATM confirmation information 204 and 206.

FIG. 9B illustrates an example of a point-to-point application that is “upstream intensive.” An upstream intensive application is utilized when there is a desire to move information as quickly as possible from the DTU-R 100 to the DTU-C 102. In an upstream intensive application, most of the transmission duration is dedicated to the upstream transmission with the exception of the downstream confirmation information. This downstream confirmation information is dictated by the link layer communication protocol. As shown in FIG. 9B, the upstream transmission of the ATDD ATM data 208 and 210 is interspersed with the downstream ATDD ATM confirmation information 212 and 214.

FIG. 9C illustrates an example of a point-to-point application that is “symmetrical” where the desire is to concurrently transfer as quickly as possible approximately equal amounts of information from the DTU-C 102 to the DTU-R 100, and from the DTU-R 100 to the DTU-C 102. In this case, the upstream confirmation information is included in the upstream transmission, and downstream confirmation information is included in the downstream transmission, as dictated by the link layer communication protocol. As shown in FIG. 9C, the downstream ATDD ATM data 216 and 218 transmission duration is approximately equal to the transmission duration of the upstream ATDD ATM data 220 and 222.

FIG. 9D illustrates an example of a variation of the above-described three point-to-point applications where the communication needs sequentially change in time from upstream intensive to downstream intensive as the upstream application is completed. As shown in FIG. 9D, the maximum upstream ATDD ATM data transmission 224 and 226 concludes, thereby allowing maximum downstream ATDD ATM data transmission 228 to occur. During the upstream intensive transmission, the downstream ATDD ATM data 230 includes confirmation information. Then during the downstream intensive transmission, the upstream ATDD ATM data transmission 232 includes confirmation information.

The amount of information communicated is the product of data rate and transmission duration. For example, 1 megabit of information can be communicated in 10 seconds at 100 kbps or in 100 seconds at 10 kbps.

To optimize the various communications needs described above, the transmission duration in each direction is varied according to the immediate and changing demands of the application or applications while utilizing the maximum downstream data rate and the maximum upstream data rate.

In an alternative embodiment of the present invention, the half-duplex data communications apparatus and method provide for automatic control of all communications on the subscriber line by the DTU-C 102. This automatic control by the DTU-C 102 is accomplished in such a way that the subscriber line data rate capacity is optimally utilized at all moments. This automatic control by the DTU-C 102 also avoids collisions between all DTUs, and offers the selection of service priorities for data throughput between each DTU-R 100 and the DTU-C 102.

In another alternative embodiment of the present invention, the half-duplex data communications apparatus and method provide for direct control of all DTU subscriber line signals from the sensing of data transmission needs of the data protocols above the physical media dependent layer. The transmissions directives are thus derived from higher layer protocols without the need for non-data interfaces.

The embodiment or embodiments discussed herein were chosen and described to provide the best illustration of the principles of the invention and its practical application to thereby enable one of ordinary skill in the art to utilize the invention in various embodiments and with various modifications as are suited to the particular use contemplated. It is not intended to be exhaustive or to limit the invention to the precise forms disclosed. All such modifications and variations are within the scope of the invention as defined by the appended claims when interpreted in accordance with the breadth to which they are fairly and legally entitled.

What is claimed is:

1. A communication device which communicates data in an asynchronous transfer mode (ATM) format comprising:
at least one buffer configured to receive data from a sending device; and
a modulation unit coupled to the buffer and configured to encapsulate at least one ATM cell into an ATM frame, the ATM cell having the received data, so that the ATM frame is communicated onto a subscriber line, such that the communicated ATM frame has a variable transmission duration, the variable transmission duration corresponding to a number of ATM cells encapsulated into the ATM frame.

2. The communication device of claim 1, wherein the ATM frame comprises a preamble, the preamble having at least an address identifying a remote data terminal unit (DTU-R), such that a selected one of a plurality of DTU-Rs receives the communicated ATM frame according to the address in the preamble.

3. The communication device of claim 1, wherein the modulation unit is further configured to parse the- received data into a plurality of data portions, and further configured to load information corresponding to each one of the plurality of data portions into a corresponding one of the ATM cells.

4. The communication device of claim 1, further comprising a unique address identifying the communication device from a plurality of other communication devices coupled to the same subscriber line, such that when a poll ATM frame having an address that corresponds to the unique address identifying the communication device is received, the communication device communicates a response frame having a duration of transmission that corresponds to the amount of data residing in the at least one buffer.

5. The communication device of claim 1, further comprising a central office data terminal unit (DTU-C) wherein the modulation unit resides, the DTU-C configured to generate a preamble and encapsulate the preamble into the ATM frame, the preamble having at least an address identifying a selected one of a plurality of remote data terminal units (DTU-Rs) coupled to the DTU-C via the subscriber line, such that the selected one of the DTU-Rs responds with a second ATM frame in response to receiving the ATM frame.

6. The communication device of claim 1, further comprising a remote data terminal unit (DTU-R) wherein the modulation unit resides, the DTU-R configured to receive a poll from a central office data terminal unit (DTU-C), the poll having at least an address identifying the DTU-R, such that the ATM frame is communicated to the DTU-C in response to receiving the poll.

7. The communication device of claim 6, wherein the first DTU-R is coupled to the DTU-C and at least one other DTU-R via the subscriber line, and wherein the address of the DTU-R uniquely identifies the DTU-R and wherein a second address uniquely identifies the other DTU-R.

8. A method for communicating data in an asynchronous transfer mode (ATM) format, the method comprising the steps of:
receiving data;
loading information corresponding to the received data into at least one ATM cell having a predefined size;
encapsulating the at least one ATM cell into an ATM frame; and
communicating the ATM frame onto a subscriber line, such that the communicated ATM frame has a variable transmission duration, the variable transmission duration corresponding to a number of ATM cells encapsulated into the ATM frame.

9. The method of claim 8, wherein the step of encapsulating the at least one ATM cell into the ATM frame further comprises the steps of:
encapsulating a preamble into the ATM frame, the preamble having at least an address identifying a remote data terminal unit (DTU-R); and
communicating the ATM frame to a selected one of a plurality of DTU-Rs according to the address in the preamble.

10. The method of claim 8, further comprising the step of communicating the ATM frame by a central office data terminal unit (DTU-C), wherein the received data is generated by a device communicating the data to the selected DTU-R.

11. The method of claim 8, further comprising the step of communicating a poll by a central office data terminal unit (DTU-C) to the selected DTU-R such that the selected DTU-R communicates the ATM frame to the DTU-C in response to receiving the poll.

12. The method of claim 11, further comprising the step of communicating a second poll by the DTU-C to a second selected DTU-R such that the second selected DTU-R communicates a second ATM frame to the DTU-C in response to receiving the second poll.

13. The method of claim 12, wherein the DTU-C, the selected DTU-R and the second selected DTU-R communicate on a common communication medium.

14. The method of claim 13, wherein the common communication medium comprises at least one selected from a group consisting of a wireless system, an optical system and a wire system.

15. The method of claim 8, further comprising the step of adjusting a transmission signal power level associated with the communicated ATM frame communicated to the selected DTU-R, the adjusted transmission signal power level corresponding to a noise level condition at the selected DTU-R.

16. The method of claim 8, wherein the step of loading information corresponding to the received data into the at least one ATM cell further comprises the steps of:
parsing the received data into a plurality of data portions having information corresponding to a respective portion of the received data; and
loading each one of the plurality of data portions into a corresponding one of the ATM cells.

17. The method of claim 8, further comprising the step of communicating the ATM frame in response to a poll received from a central office data terminal unit (DTU-C), wherein the poll indicates that the communication of the ATM frame is permissible by a remote DTU residing in a user premises, and wherein the received data is generated by a device residing in the user premises and received by the remote DTU.

18. The method of claim 8, further comprising the step of specifying a maximum number of ATM cells encapsulated into the ATM frame and such that duration of the variable transmission duration is limited.

19. A method for adjusting a duration that an asynchronous transfer mode (ATM) frame is transmitted over a subscriber line, the method comprising the steps of:
receiving data;
parsing the received data into a plurality of data portions having information corresponding to a respective portion of the received data, each one of the data portions configured to be loaded into one of a plurality of ATM cells having a predefined size;
loading each one of the data portions into a corresponding one of the plurality of ATM cells until all the data portions have been loaded;
generating the ATM frame by encapsulating the plurality of ATM cells into the ATM frame; and
communicating the ATM frame onto the subscriber line, such that the communicated ATM frame has a variable transmission duration, the variable transmission duration corresponding to a number of the plurality of ATM cells encapsulated into the ATM frame.

20. The method of claim 19, further comprising the steps of:
defining a maximum number of ATM cells that can be encapsulated into the ATM frame;
loading each one of the ATM cells with one of the plurality of data portions until the last ATM cell is loaded; and
encapsulating the maximum number of loaded ATM cells into the ATM frame, such that remaining data is communicated at a later time in a subsequently generated ATM frame such that a duration of transmission of the communicated ATM frame corresponds to the maximum number of ATM cells.

21. The method of claim 19, further comprising the steps of:
defining a maximum number of ATM cells that can be encapsulated into the ATM frame;
loading each one of the ATM cells with one of the plurality of data portions until all of the data portions are loaded; and
encapsulating only the loaded ATM cells into the ATM frame such that a duration of transmission of the communicated ATM frame corresponds to the number of loaded ATM cells.

22. The method of claim 19, further comprising the steps of:
communicating a poll ATM frame having an address to a plurality of remote data terminal units (DTU-Rs), each one of the DTU-Rs identified by a unique address; and
receiving a response ATM frame only from the DTU-R having the unique address that corresponds to the address in the poll ATM frame.

23. The method of claim 19, further comprising the steps of:
receiving a poll ATM frame having an address from a central office data terminal unit (DTU-C) by one of a plurality of remote data terminal units (DTU-Rs), each one of the DTU-Rs identified by a unique address; and
communicating a response ATM frame only by the DTU-R having the unique address that corresponds to the address in the poll ATM frame.

24. The method of claim 23, wherein the plurality of DTU-Rs and the DTU-C are coupled together via a subscriber loop.

25. A communication device for data in an asynchronous transfer mode (ATM) format, comprising:
means for receiving data;
means for loading information corresponding to the received data into at least one ATM cell having a predefined size;
means for encapsulating the at least one ATM cell into an ATM frame; and
means for communicating the ATM frame onto a subscriber line, such that the communicated ATM frame has a variable transmission duration, the variable transmission duration corresponding to a number of ATM cells encapsulated into the ATM frame.

26. The communication device of claim 25, further comprising:
means for encapsulating a preamble into the ATM frame, the preamble having at least an address identifying a remote data terminal unit (DTU-R); and
means for communicating the ATM frame to a selected one of a plurality of DTU-Rs according to the address in the preamble.
